(19) United States
(12) Patent Application Publication
(10) Pub. No.: US 2010/0245904 A1
(43) Pub. Date: Sep. 30, 2010

(54) IMAGE TRANSFER SYSTEM, DATA TRANSFER METHOD AND PROGRAM

(75) Inventors: Masashi Nishiyama, Tokyo (JP); Jumpei Sano, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/728,078

(22) Filed: Mar. 19, 2010

(30) Foreign Application Priority Data
Mar. 27, 2009 (JP) 2009-078351

(51) Int. Cl. G06F 3/12

(52) U.S. Cl. 358/1.15

(57) ABSTRACT

A first image processing apparatus makes a request to the second image processing apparatus to issue identification information to transfer second image data that a second image processing apparatus has received from the communication apparatus to the first image processing apparatus, and transmits first image data to be transmitted to the communication apparatus, and transmission destination information for identifying the communication apparatus, to the second image processing apparatus via a network.

### BACKGROUND OF THE INVENTION

1. Field of the Invention

The present invention generally relates to image processing, and more particularly to an image transfer system including an image processing apparatus connected to a network, and an image processing apparatus for transferring image data received from the image processing apparatus to a communication apparatus connected to a public line.

2. Description of the Related Art

In recent years, reduction in costs and effective use of resources have been achieved by sharing resources, such as facsimile (hereinafter, referred to as “FAX”) communication apparatuses and telephone lines via a network. Many of these are achieved by the applications of FAX sending/receiving/transfer techniques, and techniques for solving various technical problems arising along with the transfer are also known (see Japanese Patent Application Laid-Open No. 9-51395).

By using the FAX sending/receiving/transfer techniques, it becomes possible to perform transmission transfer of FAX via a FAX transmission server having FAX functions from a client sending FAX which does not have FAX functions. If a personal computer (PC) acts as a sending client, electronic documents on the PC are faxed from the FAX transmission server connected to the network by a FAX driver. Also, in a similar way, a copying machine, or a multifunction peripheral which does not have FAX communication functions can act as a sending client, and that electronic documents can be sent as a FAX via the FAX transmission server connected to the network.

When a FAX is received, a FAX reception server having a FAX receiving function performs reception transfer to a FAX receiving client which does not have the FAX receiving function, and received documents can be output at the client side. In other words, the FAX reception server computerizes the received documents, and transfers them to an email address, another FAX apparatus or a printer in accordance with the transfer condition registered in advance. In this process, the reception and transfer function generally combines and utilizes acquirable information as to FAX communication protocols such as sender number and F code as the transfer condition.

If FAX communication is regarded as a bidirectional communication means between a sender and a recipient, it is desirable to easily realize a communication in which a reply FAX to a FAX transmission sent from a client can be received and output in transmission-transfer by the same client. Such a bidirectional communication can be realized by the above-mentioned conventional technique combining the transmission-transfer and reception-transfer functions. However, there has been a problem that, for this purpose, a user must perform operations and settings which are troublesome and require time and effort.

Firstly, a user at the other end which replies to a FAX, needs to perform FAX transmission in consideration of the content of the reception-transfer condition set in a reception server when the same client receives the reply FAX. In this case, if the user fails to send the FAX in compliance with the reception-transfer condition, the FAX from the user at the other end remains in the reception server and is not transferred, and never reaches the receiving client. In other words, if the sender and the recipient do not exchange the content of the reception-transfer condition, the bidirectional communication will not be established.

Secondly, if the reception-transfer condition is not registered in the reception server, it takes time and operation to register the complicated reception-transfer condition including sender number and F code, and selection of receiving client.

Thirdly, if a client dynamically selects a reception server having a free line in a system in a case where a plurality of reception servers exist in distributed pattern, it becomes difficult for the user to know in advance to which reception server the user should set the reception transfer. For this reason, the similar reception-transfer settings need to be made for all reception servers.

### SUMMARY OF THE INVENTION

The present invention is directed to providing a scheme in which image data received from an image processing apparatus at a client side can be sent to an external communication apparatus by a simple operation, or the image processing apparatus at the client side can receive image data that the image processing apparatus at the server side has received from a communication apparatus.

According to an aspect of the present invention, in an image transfer system, a second image processing apparatus transfers first image data, which is received from a first image processing apparatus via a network, to a communication apparatus connected to a public line. The first image processing apparatus includes a request unit configured to make a request to the second image processing apparatus for issuance of identification information to transfer second image data, which the second image processing apparatus has received from the communication apparatus, to the first image processing apparatus, and a first transmission unit configured to transmit first image data to be transmitted to the communication apparatus, and transmission destination information for identifying the communication apparatus, to the second image processing apparatus via the network. The second image processing apparatus includes an issuing unit configured to issue identification information for transferring second image data received from the communication apparatus to the first image processing apparatus, based on a request from the first image processing apparatus, a second transmission unit configured to transmit the first image data received from the first image processing apparatus, and the identification information, to the communication apparatus that is identified by the transmission destination information, and a transfer unit configured to acquire identification information from the second image data received from the communication apparatus, and transfer the second image data via the network to the first image processing apparatus that is identified by the acquired identification information.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image transfer system.

FIG. 2 is a block diagram illustrating a detailed configuration of a multifunction peripheral (MFP).

FIG. 3 is a flowchart illustrating data transfer processing of the image transfer system.

FIG. 4 illustrates a user information table to be stored in a storage unit.

FIG. 5 illustrates an example of user interface (UI) displayed on an operation panel unit.

FIG. 6 illustrates transmitted original image and received image.

FIG. 7 illustrates a transfer condition table that the MFP stores.

FIG. 8 is a flowchart illustrating the data transfer processing of the image transfer system.

FIG. 9 is a flowchart illustrating the data transfer processing of the image transfer system.

FIG. 10 illustrates an example of the UI displayed on the operation panel unit.

FIG. 11 illustrates an example of the UI displayed on the operation panel unit.

FIG. 12 illustrates an example of the UI displayed on the operation panel unit.

### DESCRIPTION OF THE EMBODIMENTS

Various exemplary embodiments, features, and aspects of the invention will be described in detail below with reference to the drawings.

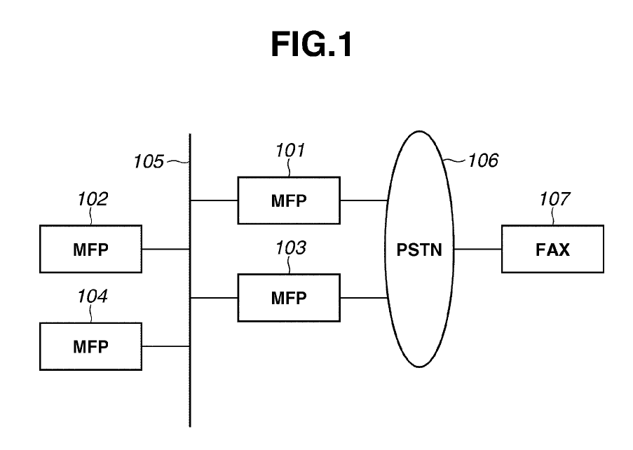

Hereinbelow, a first exemplary embodiment of the present invention will be described in detail with reference to the drawings. FIG. 1 is a block diagram illustrating a configuration of an image transfer system according to the exemplary embodiments of the present invention. In the present exemplary embodiment, an image transfer system includes, as an example, an image processing apparatus at a client side having no facsimile communication function via a network, and an image processing apparatus at a server side that performs data communication with a facsimile apparatus via a public line. Further, the image processing apparatuses at the server side and at the client side are multifunction peripherals (MFPs) which will be described below. A communication apparatus is assumed to be a facsimile apparatus, as an example. However, the image processing apparatus may be constituted by an information processing apparatus connected to an image reading apparatus or a printer apparatus.

Further, as long as an apparatus has a configuration including facsimile communication software and communication controller, the apparatus is not limited to the facsimile apparatus, and thus an information processing apparatus including the relevant facsimile communication software, and the communication controller may act as the facsimile apparatus.

In FIG. 1, multifunction peripherals (MFPs) 101, 102, 103, and 104, which each include a copying function, a printing function, and a transmission function, are connected to a network 105. The MFPs 101 and 103 and a FAX 107 are connected to a PSTN 106. PSTN is an abbreviation for “Public Switched Telephone Network”, which includes telephone subscriber networks, general public networks, and public telephone lines.

In the present exemplary embodiment, a plurality of first image processing apparatuses including no facsimile communication function are constituted by the MFPs 102 and 104, and a plurality of second image processing apparatuses including the facsimile communication functions are constituted by the MFPs 101 and 103. The MFPs 102 and 104 and the MFPs 101, 103 are connected to one another via the network 105, and the MFPs 101 and 103 are connected to the FAX 107 via the PSTN 106.

Further, in the description hereinafter, the network 105 is typically constituted by a local area network (LAN) and a wide area network (WAN), but can be replaced by different network configurations as long as data transmission and reception can be implemented among the MFPs 101 to 104. The PSTN 106 is typically a public telephone line, but a network configuration capable of performing FAX communications, such as an integrated services digital network (ISDN), an Internet protocol (IP) network, a dedicated line, and/or the like, is also acceptable.

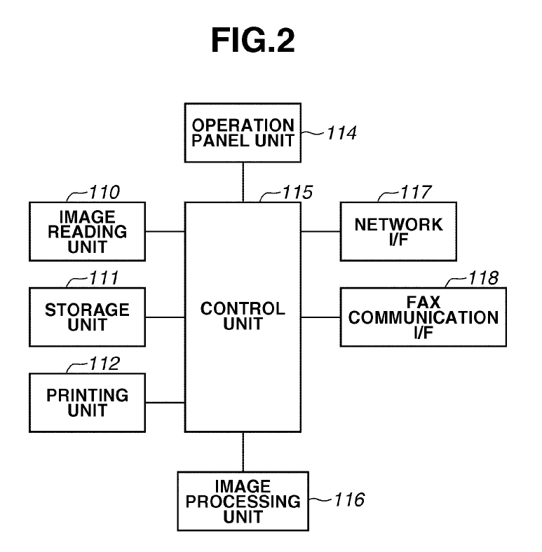

Next, a configuration of the MFPs 101 to 104 will be described with reference to FIG. 2. FIG. 2 is a block diagram illustrating a detail configuration of the MFPs 101 to 104 illustrated in FIG. 1. In FIG. 2, an image reading unit 110 including an automatic original feeding apparatus (AOF) outputs original images obtained by optically reading out originals as digital image data. A storage unit 111 stores the image data read out by the image reading unit 110 and other data.

A printing unit 112 prints the image data to be stored in the storage unit 111, on a recording medium. An image processing unit 116 reads out images to be stored in the storage unit 111 and subjects the images to image processing. Then, the image processing unit 116 again outputs the images to the storage unit 111. An image processing circuit for image reading and printing is included in the image reading unit 110 and the printing unit 112, respectively.

The MFPs 101-104 are connected to the network 105 via a network interface (I/F) 117, and can be connected to the PSTN 106 via a FAX communication I/F 118. In a configuration of the system illustrated in FIG. 1, the system is configured such that the MFPs 102 and 104 are not connected to the PSTN 106. Instructions by an operator (user) to the MFPs 102 and 104 are given from an operation panel unit 114. The operation panel unit 114 is constituted by a touch panel, and displays operation screen data and receives input from the user.

The operation panel unit 114 can be constituted by, instead of the touch panel, other input devices, such as keyboard, mouse, and/or the like, and display devices, such as a liquid crystal display, a thin-film transistor liquid crystal display, and/or the like. A control unit 115 controls a series of operations through interactions with the user via the operation panel unit 114, the image reading unit 110, the storage unit 111, the printing unit 112, the image processing unit 116, the network I/F 117, and the FAX communication I/F 118. Thus, the control unit 115 realizes multiple functions of the MFPs. Further, in the present exemplary embodiment, the FAX 107 takes a configuration similar to those of the MFPs, but may take a configuration of a normal facsimile apparatus including no multiple functions.

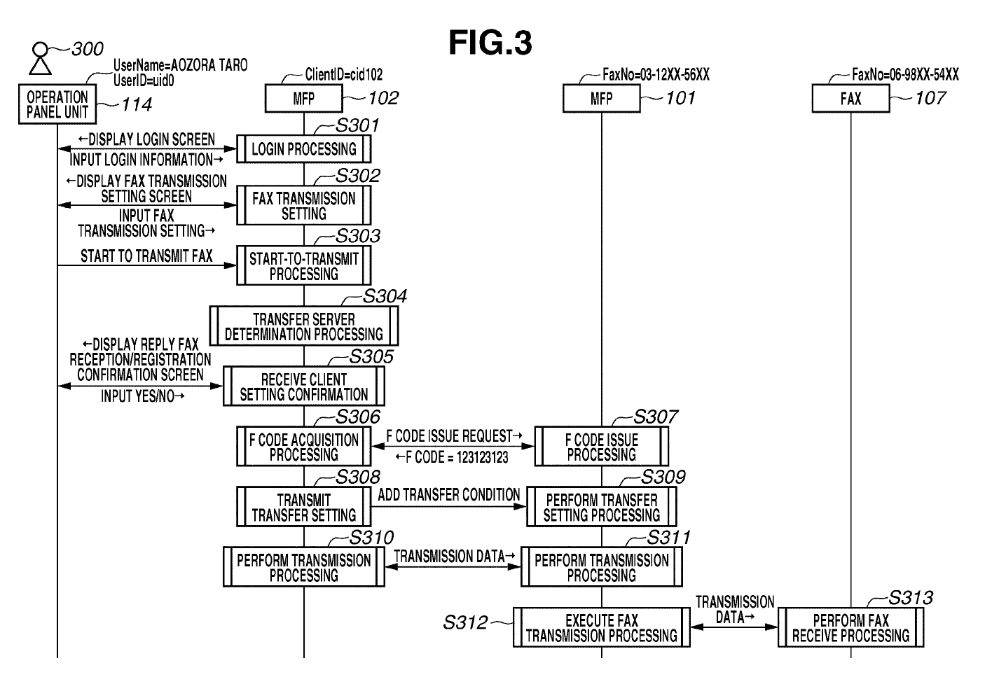

Next, a flow of data transmission and transfer in the image transfer system according to the present exemplary embodiment will be described with reference with FIG. 3. In the present exemplary embodiment, the MFP 101 and the MFP 103 are connectable to the PSTN 106. Therefore, the MFP 101 and the MFP 103 perform processing of transferring image data from the MFPs 102 and 104 to the FAX 107, and processing of transferring facsimile data received from the FAX 107 to the MFPs 102 and 104.

FIG. 3 is a flowchart illustrating data transfer processing of the image transfer system illustrated in FIG. 1. The flowchart includes steps S301 to S313. Respective steps in the MFPs 101 and 102 are implemented by causing the control unit 115, illustrated in FIG. 2, to load and execute a control program on the storage unit 111. Further, processing in step S313 is implemented by causing a central processing unit (CPU) of the FAX 107 to load and execute a control program stored in a read-only memory (ROM), on a random access memory (RAM). Hereinbelow, processing in which a user 300 sends original data read out by the MFP 102 to the FAX 107 will be described as an example. Processing of receiving data from the FAX 107 will be described below.

The image data in the flow is sent from MFP 102 to the FAX 107 through the following flow. Firstly, the MFP 102 sends image data of originals that have been read out by the image reading unit 110 to the MFP 101 connected via the network 105 thereto. Next, the MFP 101 transmits the image data of the originals received from the MFP 102 to the FAX 107 connected to the PSTN 106. Then, the FAX 107 prints and outputs FAX-received image received from the MFP 101. The details of the flow will be described below.

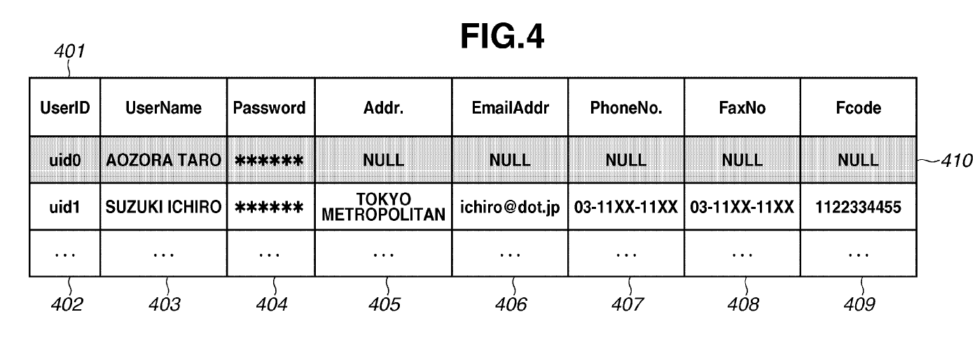

The MFP 102 includes a login function. First, the user 300 who operates the operation panel unit 114 logs in to the MFP 102 through login processing in step S301. The MFP 102 stores a user information table 401, illustrated in FIG. 4, in the storage unit 111, and implements a known login function based on the user name and password using this table. FIG. 4 illustrates an example of the user information table 401 to be stored in the storage unit 111, illustrated in FIG. 2. In FIG. 4, the user information table 401 is made up of a UserID 402, a UserName 403, a Password 404, an Addr 405, an EmailAddr 406, a PhoneNo 407, a FaxNo 408, and an Fcode 409.

The UserID 402 is an identifier (ID) for uniquely identifying a user who operates the MFP 102. The UserName 403 and the Password 404 are a user name (login name) and a password necessary for a user authentication when logging in. The Addr 405 is postal address information of the user. The Emailaddr 406 is an e-mail address of the user. The PhoneNo 407 is a telephone number of the user. The FaxNo 408 is a Fax number of the user. The Fcode 409 is an F code to be used in conjunction with the FaxNo 408 when a FAX is sent and transferred to the user. In the user information table 401, the above information which is not yet registered, is stored by a value of NULL. The user who operates the operation panel unit 114 is stored on a column 410 of the user information table 401, and the UserID 402 of the user is registered as “uid0”, and the UserName 403 as “Aozora Taro”.

Next, in step S302, in the MFP 102, the control unit 115 performs FAX transmission setting processing. In this processing, the control unit 115 controls the operation panel unit 114 to display a FAX transmission setting screen, and inputs FAX transmission settings through interaction with user via the displayed GUI. The GUI is an abbreviation for graphical user interface. Through this processing, setting information of the FAX 107, such as FAX number “06-9876-5432” and transmission resolution, is input into the MFP 102.

Next, upon receiving a FAX transmission start request, FAX transmission processing in step S303 is started by pressing a start button (not shown) on the operation panel unit 114 by the user. In this process, the control unit 115 performs processing of reading out all originals that the user has placed on the image reading unit 110 in accordance with transmission settings until they are all stored in the storage unit 111. Then the processing proceeds to step S304. In step S304, the control unit 115 performs transmission destination selection to select an image processing apparatus at a server side that performs FAX transfer. In the processing, the originals are automatically fed from the automatic original feeding apparatus.

In the present exemplary embodiment, since the MFP 101 and the MFP 103 can transfer FAX to the FAX 107 via the PSTN 106, the processing selects one of the MFP 101 and the MFP 103 as the image processing apparatus at the server side. In this processing, as an algorithm for selecting an image processing apparatus at a server side, a line which is not occupied is to be selected out of lines connected to the PSTN 106. Further, if both lines are occupied, a line on which calling is finished earlier, is selected. If both lines are unoccupied, any line is arbitrarily selected.

In step S304, the control unit 115 has selected an image processing apparatus at a server side in accordance with a certain algorithm. However, the user may register the image processing apparatus at the server side in advance, and a transmission server may be accordingly determined. In this way, in step S304, when the MFP 101 is selected as the image processing apparatus at the server side, in step S305, the control unit 115 performs setting confirmation processing in an image processing apparatus at a client side.

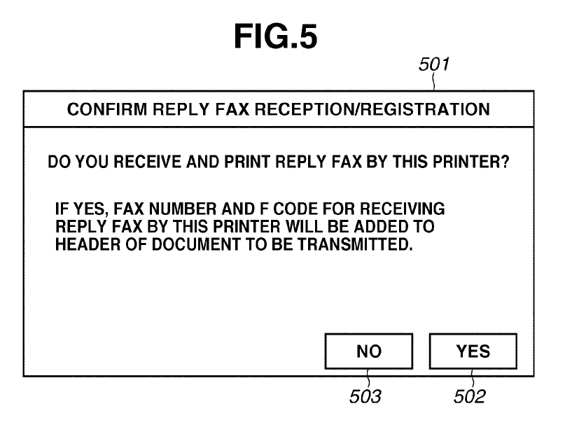

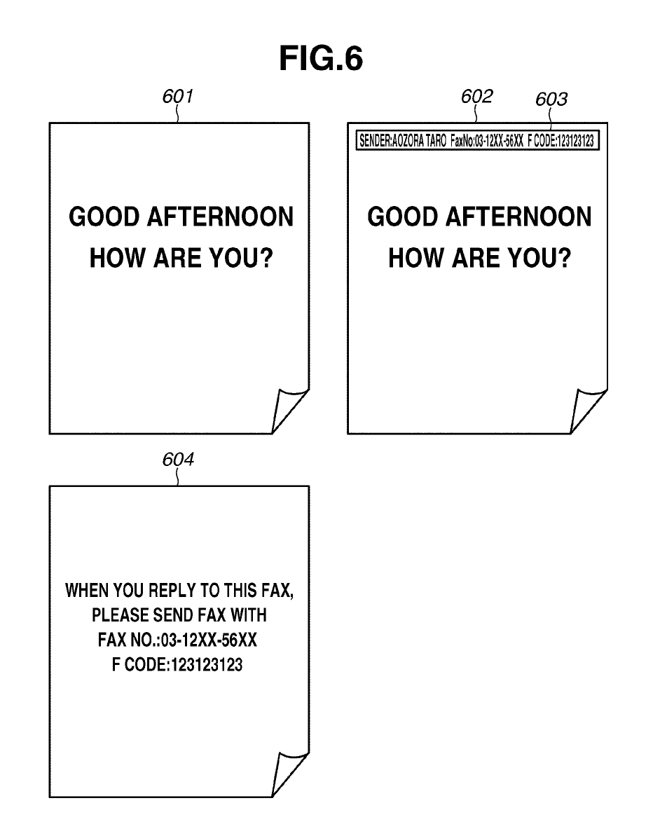

In this process, the control unit 115 displays a screen 501 for confirming reply FAX reception/registration, illustrated in FIG. 5, on the operation panel unit 114, and induces the user to select YES/NO. In this process, if the user selects a button 502 corresponding to YES, FAX number 03-1234-5678 of the MFP 101 working as a server, and information including F code to be acquired in the next step S306, are added to received image to be received in the FAX 107. The FAX number 03-1234-5678 of the MFP 101 is transmission destination information to be notified to the FAX 107, which is referred to when the FAX 107 replies to the FAX. More specifically, a sent original 601, illustrated in FIG. 6, is received in the form of a received image 602 by the FAX 107. In a header part 603 surrounded by a short dashed line, a sender name, a FAX number of the MFP 101, and F code are described as sender information.

Further, if the user selects a button 503 corresponding to NO, in the screen 501 confirming reply FAX reception/registration, illustrated in FIG. 5, F code is not described in the header part. In the present exemplary embodiment, the FAX number and the F code are added to the header part as readable character string, but a position where the information is added is not limited to the header part. A type of information other than the readable character string, such as a bar code, can also be used as the information to be added. Further, an image 604 describing a reply method may be separately created.

Next, in step S305, the control unit 115 of the MFP 102 performs setting confirmation processing in the image processing apparatus at the client side. In this process, the control unit 115 displays the screen 501 for confirming reply FAX reception/registration illustrated in FIG. 5 on the operation panel unit 114, and induces the user to select buttons corresponding to YES/NO. When the user selects the button 502 corresponding to YES, the processing proceeds to step S306. Then, in step S306, which is F code acquisition processing, the MFP 102 performs F code issue request to the MFP 101. At this time, the MFP 102 notifies together the MFP 101 of cid102 as a client ID of the MFP 102. The MFP 101, which has received the F code issue request from the client of cid102, performs F code issue processing in step S307, issues a new F code which is not yet used, and notifies the MFP 102 of the issued F code. In this process, the F code is used as identification information for the MFPs 101 and 102 to identify the MFPs 102 and 104 connected to the network 105 when transferring reception data received from the FAX 107 via the PSTN 106.

In an example in FIG. 3, the MFP 101 issues the F code of “123123123”, and notifies the MFP 102 thereof. When the MFP 102 receives the F code of “123123123” from the MFP 101, the processing proceeds to step S308. Then, in step S308, the MFP 102 sends transfer setting to the MFP 101. The F code of “123123123” acquired in step S306 and a client ID (cid102) are sent as transfer setting. In step S309, the MFP 101, which has received the transfer setting from the MFP 102, performs transfer setting processing.

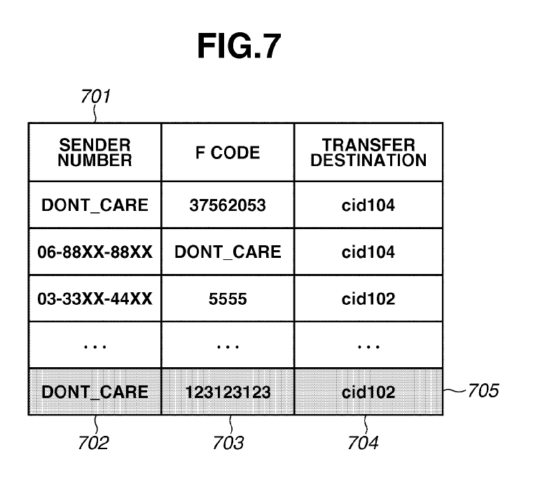

FIG. 7 illustrates an example of a transfer condition table 701 that the MFP 101, illustrated in FIG. 1, stores. In FIG. 7, the transfer condition table 701 is made up of a sender No. column 702, an F code column 703, and a transfer destination column 704. The MFP 101, upon receiving FAX from the FAX 107, refers to the transfer condition table 701, determines whether the received sender No. and the F code coincide with the ones registered in the transfer condition table 701. Then, if the MFP 101 determines that the received sender No. and F code are registered in the transfer condition table 701, the MFP 101 performs reception-transfer processing to an image processing apparatus at a client side registered for a transfer destination in accordance with the relevant transfer condition table 701.

If the MFP 101 receives, for example, a FAX from the sender No. “03-3333-4444”, and “5555” is designated to the F code, the MFP 101 transfers the received document to an image processing apparatus having a client ID, cid102. In this process, if a value of “DON'T_CARE” is registered for the sender No. or the F code, determination whether the item coincides with the condition will not be performed. The column 705 indicates that newly registered transfer condition has been added in the transfer setting processing in step S309. Accordingly, received information in which “123123123” is designated as the F code without recourse to the sender No., will be transferred to the MFP 102 corresponding to the transfer destination which is identified as the “cid102”.

Then, when the MFP 102 has completed the transfer setting in step S309, and passed through the transfer setting send processing in step S308, the processing proceeds to step S310. In step S310, the MFP 102 executes a first transmission processing of sending the image data of the originals read out in step S303 to the MFP 101. In this process, the image data corresponds to the first image data to be sent from the MFP 102 to the MFP 101. More specifically, the MFP 102 sends a FAX number “06-9876-5432” of the FAX 107, which is a destination of FAX transmission, and the next sender information, together with original image data. For the sender information, the MFP 102 sends “Aozora Taro” as a sender name, “03-1234-5678” as a sender No., and “123123123” as an F code to the MFP 101.

In step S311, the MFP 101 receives transmission data (including the image data) from the MFP 102. Next, in step S312, as second transmission processing, the MFP 101 transmits the image data received from the MFP 102, to the destination FAX 107, adding the received sender information to the header part of the image data. The processing of adding the sender information to the header part may be performed either by the MFP 102 in step S310, or by the MFP 101 in step S311. On the other hand, the destination FAX 107 performs reception processing of the FAX received from the MFP 101 in step S313, and prints and outputs the received data.

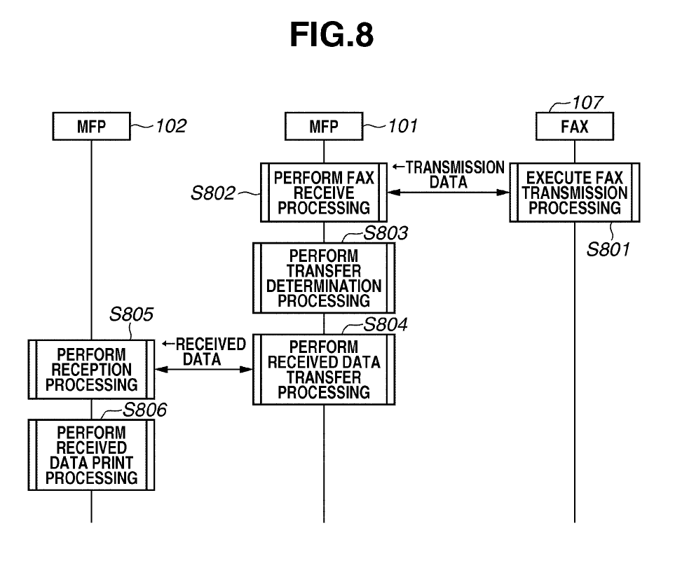

Next, a flow of reception and transfer in the image transfer system according to the present invention will be described with reference to FIG. 8. FIG. 8 is a flowchart illustrating an example of the data transfer processing in the image transfer system according to the present exemplary embodiment. The present example is a processing example of transferring the data received from the FAX 107 to the MFP 102.

Respective steps S801 to S806 in the MFPs 101 and 102 are implemented by causing the control unit 115 illustrated in FIG. 2 to load a control program to the storage unit 111 to execute it. Hereinbelow, in the present example, the FAX 107 designates the F code “123123123” and sends the FAX to the MFP 101, and performs reception and transfer of the FAX to the MFP 102 based on the F code that the MFP 101 has received.

In step S801, the FAX 107 reads out images of originals to be transmitted, and performs FAX transmission processing for transmitting the image data to the MFP 101. In this process, the image data that the FAX 107 sends to the MFP 101 corresponds to the second image data. The MFP 101, upon receiving FAX reception request from the FAX 107, performs normal FAX reception processing in step S802, and stores the received data in the storage unit 111, and the processing shifts to step S803.

In step S803, the MFP 101 performs transfer determination processing whether to transfer the received FAX to devices on the network based on the transfer condition table 701 illustrated in FIG. 7. In this process, the relevant devices are the MFPs 102 and 104. The determination here is performed as described above, based on the sender No. and the F code that are acquired in FAX reception processing in step S802. In this exemplary embodiment, the received F code “123123123” is registered in the transfer condition table 701 in column 705, and the sender No. is DONT_CARE. Hence, it is determined that, the MFP 101, irrespective of the acquired sender No., performs reception and transfer to the cid102 of the transfer destination. If it is determined not to transfer the received FAX in the present determination processing, the MFP 101 prints and outputs the received FAX on the printing unit 112 of the apparatus itself. The received FAX may also be stored in the storage unit 111, for example, a box region such as hard disk, and to print it at a designated time, or after user authentication is performed for the relevant box region.

In the transfer determination processing in step S803, the MFP 101 determines the transfer to the cid102, and the processing proceeds to step S804. Then, in step S804, the MFP 101 performs received data transfer processing and the data received in step S802 is sent to the MFP 102 identified by the cid102. In step S805, the MFP 102 that has received the transfer processing request performs reception processing of the data sent from the MFP 101, then the processing proceeds to step S806. In step S806, the MFP 102 performs print processing of the data received from the MFP 101 in step S805, and prints and outputs the reception data to the printing unit 112.

Accordingly, the MFPs 101 and 103, which can receive the FAX transmitted from the FAX 107 can identify an MFP connected to a network in accordance with the F code added to the received data, and return the image data to a designated MFP. Thus, according to the present exemplary embodiment, when users of the MFPs 102 and 104 select the MFP 101 and send the image data to the FAX 107, the MFP 101 can automatically set information for identifying the MFPs 102 and 104. Therefore, this will ease operational burdens on the users of the MFP 102 and 104 in making settings such as destination setting for receiving the image data returned from the FAX 107, and transfer destination setting on the network.

In the above-described first exemplary embodiment, transfer setting has been newly registered in the MFP 101 that works as an image processing apparatus at a server side based on the newly issued F code. Then, the issued F code has been sent to the destination FAX 107 as information of the transfer condition. In the second exemplary embodiment, processing of utilizing the transfer condition registered in the MFPs 101 and 103 that already works as the image processing apparatus at the server side will be described below.

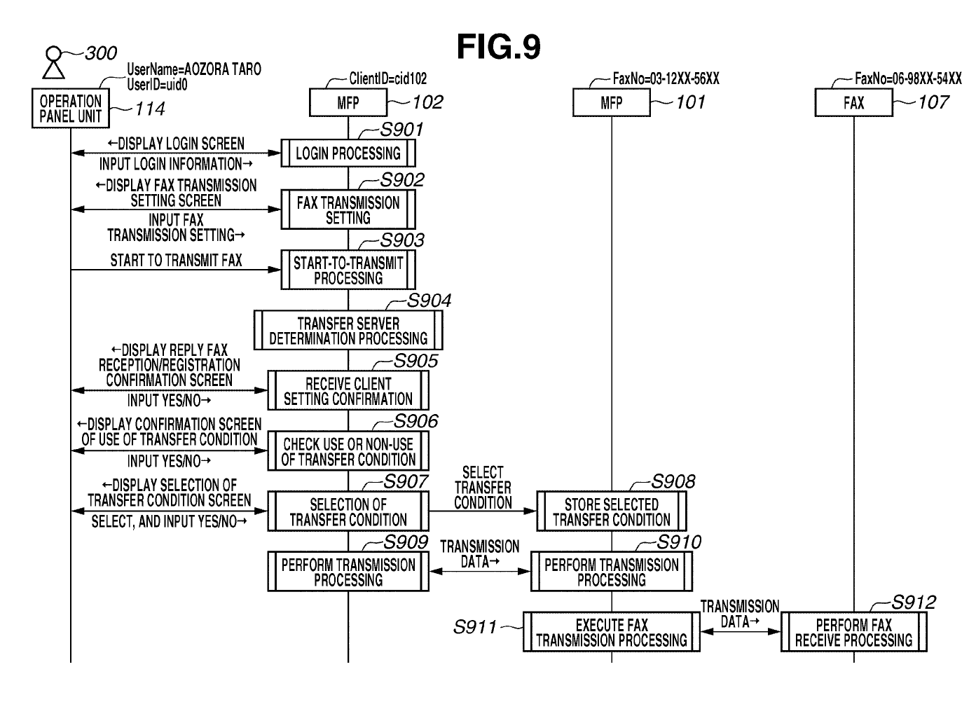

FIG. 9 is a flowchart illustrating data transfer processing in the image transfer system according to the present exemplary embodiment. Respective steps S901 to S912 in the MFPs 101 and 102 are implemented by causing the control unit 115 illustrated in FIG. 2 to load and execute a control program in the storage unit 111. Hereinbelow, transmission-transfer processing in the present exemplary embodiment will be described. Further, the processing in steps S901 to S904 are similar to those in steps S301 to S304 in the first exemplary embodiment. In the present example, processing after the MFP 102 has performed image data transfer request to the MFP 101 using FAX transmission function of the image data will be described below.

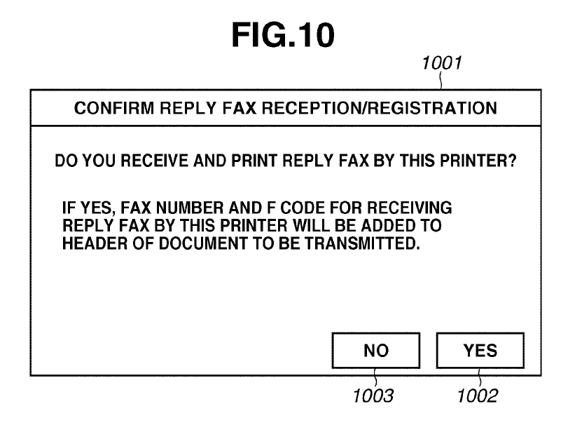

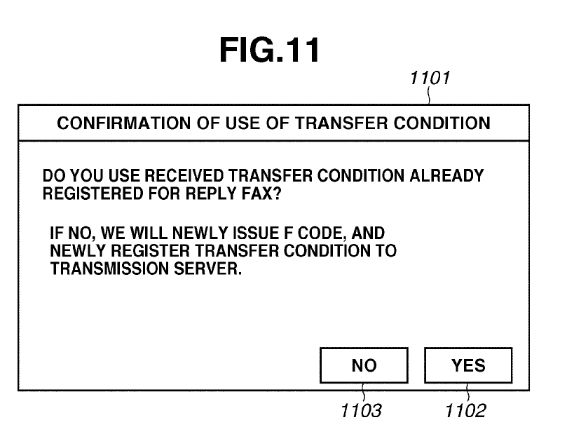

In step S905, the MFP 102 displays the reply FAX reception/registration screen on the operation panel unit 114 using the user interface illustrated in FIG. 10, and performs processing for confirming the receiving client setting. FIGS. 10-12 illustrate an example of the user interface to be displayed on the operation panel unit 114 illustrated in FIG. 2. The user interface illustrated in FIG. 10 is an example of the reply FAX reception/registration screen, and the user interface illustrated in FIG. 11 is a screen for confirming the use of the transfer condition.

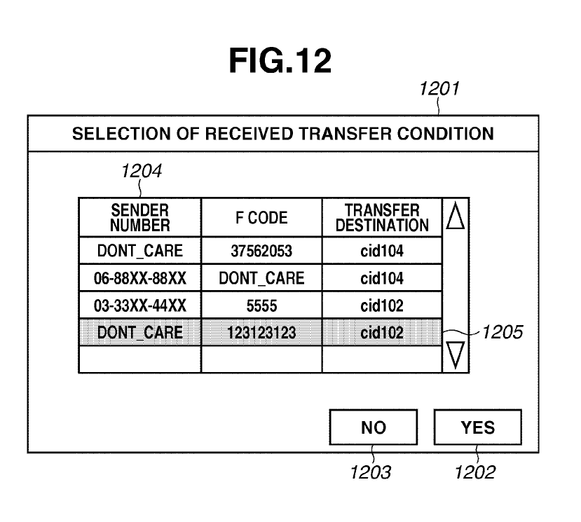

Further, the user interface illustrated in FIG. 12 is a listing screen for selecting the transfer condition. These pieces of screen information are stored in the storage unit 111, and are displayed on the operation panel unit 114 under control of the control unit 115. These pieces of screen information may be acquired from a server apparatus to display them using a browser, so that a user interface compliant with the latest function can be displayed.

In FIG. 10, the control unit 115, after having displayed the reply FAX reception/registration confirmation screen 1001 on the operation panel unit 114, induces a user to select either of the buttons 1002, and 1003 corresponding to YES/NO. In this process, when the user selects the button 1003 corresponding to YES, the processing proceeds to step S906. In this process, the control unit 115 displays the confirmation screen 1101 of the use of the transfer condition illustrated in FIG. 11 on the operation panel unit 114, and induces the user to select the button 1103, or the button 1102 corresponding to YES/NO. The control unit 115 of the MFP 102 displays the confirmation screen 1101 on the operation panel unit 114, based on the screen data received from the MFP 101. In this process, when the user selects the button 1102 corresponding to YES, the processing proceeds to step S907. On the other hand, when the user selects the button 1103 corresponding to NO, the processing is similar to that in step S306 and later in the first exemplary embodiment.

Then, in step S907, the control unit 115 displays a transfer condition selection screen 1201 illustrated in FIG. 12 on the operation panel unit 114, and induces the user to select reception-transfer condition for use in the reply FAX. The control unit 115 of the MFP 102 displays the transfer condition selection screen 1201 indicating a listing of the transfer conditions on the operation panel unit 114 based on the screen data received from the MFP 101. When the user selects the transfer condition indicated in lists 1204 and 1205 illustrated in FIG. 12, and presses the button 1202 corresponding to YES, the processing proceeds to step S908. Then, in step S908, the MFP 101 temporarily stores selected transfer condition in the storage unit 111. The transfer condition selection screen 1201 also includes a button 1203 corresponding to NO.

Next, in step S909, the MFP 102 sends only original image data to the MFP 101 via the network 105. Then, in step S910, the MFP 101 receives transmitted data from the MFP 102. Next, in step S911, the MFP 101 adds the F code and the sender No. of the transfer condition temporarily stored in step S908 to a header part of the image data received from the MFP 102, and executes FAX transmission processing to the destination FAX 107 via the PSTN 106. The reception-transfer flow is similar to that in the first the exemplary embodiment. According to the present exemplary embodiment, the users of the MFPs 102 and 104 do not need to issue the F code to the MFPs 101 and 103 for each FAX transmission request, and, as such, management burden of the F code will be reduced.

### Other Embodiments

Aspects of the present invention can also be realized by a computer of a system or apparatus (or devices, such as a CPU, Micro-Processing Unit (MPU) and/or the like) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-078351 filed Mar. 27, 2009, which is hereby incorporated by reference herein in its entirety.

What is claimed is:

1. An image transfer system in which a second image processing apparatus transfers first image data, which is received from a first image processing apparatus via a network, to a communication apparatus connected to a public line, the first image processing apparatus comprising:
a request unit configured to make a request to the second image processing apparatus for issuance of identification information to transfer second image data, which the second image processing apparatus has received from the communication apparatus, to the first image processing apparatus; and
a first transmission unit configured to transmit first image data to be transmitted to the communication apparatus, and transmission destination information for identifying the communication apparatus, to the second image processing apparatus via the network, and the second image processing apparatus comprising:
an issuing unit configured to issue identification information for transferring the second image data received from the communication apparatus to the first image processing apparatus, based on a request from the first image processing apparatus; and
a second transmission unit configured to transmit the first image data received from the first image processing apparatus, and the identification information, to the communication apparatus that is identified by the transmission destination information; and
a transfer unit configured to acquire identification information from the second image data received from the communication apparatus, and transfer the second image data via the network to the first image processing apparatus that is identified by the acquired identification information.

2. The image transfer system according to claim 1, wherein the second image processing apparatus further includes:
a storage unit configured to store transfer condition in which the identification information that the issuing unit has issued, transfer destination to which the second image data received from the communication apparatus is transferred, and sender No., are associated with one another; and
a notification unit, if an image data transfer request is received from the first image processing apparatus, configured to notify the first image processing apparatus of a listing of transfer conditions stored in the storage unit, and
wherein the first image processing apparatus includes:
a selection unit configured to select a transfer condition from among the listing of the transfer conditions notified by the notification unit.

3. The image transfer system according to claim 1, wherein the first image processing apparatus further includes a transmission destination selection unit configured to select a transmission destination for transmitting the first image data, from a plurality of second image processing apparatuses connected to the network.

4. The image transfer system according to claim 1, wherein the first image processing apparatus further includes a reading unit configured to read out an original image, wherein the first transmission unit transmits image data that the reading unit has read out, to the second image processing apparatus.

5. The image transfer system according to claim 1, wherein the communication apparatus is a facsimile apparatus that transmits and receives the image data.

6. A data transfer method in an image transfer system in which a second image processing apparatus transfers first image data, which is received from a first image processing apparatus via a network, to a communication apparatus connected to a public line, the data transfer method, wherein
the first image processing apparatus makes a request to the second image processing apparatus for issuance of identification information for transferring second image data, which the second image processing apparatus has received from the communication apparatus, to the first image processing apparatus;
the first image processing apparatus transmits first image data to be transmitted to the communication apparatus, and transmission destination information for identifying the communication apparatus, to the second image processing apparatus via the network;
the second image processing apparatus issues the identification information for transferring the second image data received from the communication apparatus, to the first image processing apparatus, based on a request from the first image processing apparatus;
the second image processing apparatus transmits the first image data received from the first image processing apparatus, and the identification information, to the communication apparatus that is identified by the transmission destination information; and
the second image processing apparatus acquires identification information from the second image data received from the communication apparatus, and transfers the second image data via the network to the first image processing apparatus that is identified by the acquired identification information.

7. The data transfer method according to claim 6, wherein the second image processing apparatus includes a storage unit configured to store transfer condition in which the issued identification information, the transfer destination to which the second image data received from the communication apparatus is transferred, and sender No., are associated with one another, the data transfer method comprising:
if image data transfer request has been received from the first image processing apparatus, notifying the first image processing apparatus of a listing of transfer conditions stored in the storage unit; and
selecting a transfer condition from the listing of the notified transfer conditions by the first image processing apparatus.

8. The data transfer method according to claim 6, comprising selecting a transmission destination for transmitting image data, from a plurality of second image processing apparatuses connected to the network, by the first image processing apparatus.

9. The data transfer method according to claim 6, wherein the communication apparatus is a facsimile apparatus that transmits and receives the image data.

10. A computer-readable medium having a program stored thereon for causing a computer to execute the data transfer method according to claim 6.
